(19) United States
(12) Patent Application Publication
(10) Pub. No.: US 2008/0169761 A1
(43) Pub. Date: Jul. 17, 2008

(54) Back plate structure of plasma display panel

(75) Inventor: Chao-Jen Chang, Padeh City (TW)

Correspondence Address: BIRCH STEWART KOLASCH & BIRCH, PO BOX 747, FALLS CHURCH, VA, 22040-0747, US

(73) Assignee: CHUNGHWA PICTURE TUBES, LTD

(21) Appl. No.: 11/979,895

(22) Filed: Nov. 9, 2007

(30) Foreign Application Priority Data
Nov. 22, 2006 (CN) 200610149591.4

(51) Int. Cl. H01J 17/49

(52) U.S. Cl. 313/582

(57) ABSTRACT

A back plate structure of the plasma display panel is provided. The horizontal barrier ribs and the vertical barrier ribs are crossed over to form the I at t i c e - Ii k e discharge cells. The horizontal barrier ribs or the vertical barr i e r r i b s have t h e projections p rot rude d to t h e discharge cells, which can make the air exhaust from the sides of the projections during the printing of the phosphor paste. The nonuniform-thickness phenomenon caused by the bubbles in the phosphor material printed on the bottom-surface of the discharge cell is improved, and so flicker-noises on the display panel are eliminated. Furthermore, the discharge space is increased owing to the increased packing-density of the phosphor material. Therefore, the illumination efficiency of the PDP is promoted. Besides, the horizontal barrier rib and the vertical barrier rib may also be designed to have a height difference to improve the exhausting efficiency during the printing process of the phosphor paste.

### BACKGROUND OF THE INVENTION

1. Field of the Invention

The present invention relates to a structure on barrier rib for the back plate of the Plasma Display Panel (PDP), and more particularly, to a structure with projections on the barrier ribs.

2. Description of the Prior Art

Recently, the technology is developing rapidly on various types of flat panel displays, such as the Liquid Crystal Display (LCD), Field Emission Display (FED) and plasma display panel (PDP). In the different Flat Panel Displays (FPDs), the PDP has many advantages including simple structure, easily to be produced as a large-scale display, longer life time, widely viewing angle which is greater than 160°, thinner module, space saving and not heavy. As the result, it is widely applied on large-scale display apparatuses, such as a large-scale FPD television.

The basic technology theory on PDP is that an electrical field applys to the inert gas, for instance, Ne, He and Xe, to produce a discharge phenomenon and ultra-violate radiations. After that, the phosphor materials excite visible light by the ultra-violate radiations.

The display area on the PDP is formed by a plurality of image cells, however, the new generation of PDP is normally constituted by horizontal barrier ribs and vertical barrier ribs to form the lattice-like discharge cells. Regarding to the prior art from FIG.IA to FIG.1C, FIG.IA is a top-view schematic diagram for partial discharge cells, FIG. 1B is a top-view schematic diagram for a single discharge cell, and FIG.IC is a cubic schematic diagram for a single discharge cell. Vertical barrier ribs 14 and horizontal barrier ribs 16 intersect to form right angles for an enclosed space on each discharge cell 12.

Generally, the discharge cell 12, which includes the bottom and lateral surfaces, is surrounded by phosphor materials to provide more exciting area to increase the illumination efficiency of the PDP. A mesh screen corresponding to the discharge cell is adopted to an aligned printing of the phosphor material. FIG.ID is a schematic diagram to demonstrate the phosphor printing for the prior art. A plurality of address electrodes 20 is printed on a glass substrate 18, and a dielectric layer 22 is printed on the glass substrate 18 and covered the address electrodes 20. A plurality of horizontal barrier ribs 16 is printed on the dielectric layer 22, and the space between two adjacent horizontal barrier ribs 16 is the discharge cell 12. The phosphor paste 26 is printed into the discharge cell 12 through the net of a mesh screen 24 by using a squeegee 28. However, the bubbles 32 are easily to be produced during the phosphor printing. Thus, thickness uniformity on the phosphor materials is not in good quality after the solvent of the phosphor paste 26 is evaporated by a firing procedure. As shown in FIG. 1E, the thickness of the phosphor material 34 on the discharge cell 12 is not uniform, and the pinholes 36 may be produced on the bottom surface due to the non-uniform thickness. As a result, the illumination efficiency of the image cell is poor and flicker-noises would be produced on the display panel.

### SUMMARY OF THE INVENTION

In order to solve the aforementioned problems of the non-uniform thickness phenomenon in a conventional PDP, which is caused by the bubbles produced during the phosphor printing. One object of the present invention is to provide a structure with projections on barrier ribs, and the air would be exhausted from the I ate r a Isurface of the projections during the phosphor printing. Therefore, the phosphor material can be printed on the bottom and lateral surfaces of the discharge cell uniformly.

In order to solve the aforementioned problems of the poor illumination efficiency and flicker-noises on display panel in a conventional PDP, one object of the present invention is to provide a structure with projections on barrier ribs to eliminate flicker-noises on the display panel and increase the illumination efficiency.

One object of the present invention is to provide a st ructure with projections on barrier ribs for the back plate of a PDP to increase the packing density of the phosphor material, and so as to enlarge the discharge space of the discharge cell.

One object of the present invention is to provide a structure with projections on barrier ribs for the back plate of a PDP, wherein the horizontal barrier ribs and the vertical barrier ribs have height difference to improve the exhausting efficiency during the printing process of the phosphor paste.

Consequently, a structure with projections on barrier ribs for the back plate of a PDP in the present invention can improve the nonuniform thickness of the phosphor material in the discharge cell and increase the packing density of the phosphor material to enlarge the exciting area. By this way, it can resolve the problem of the flicker-noises on the display panel, and increase the process yield and illumination efficiency.

To achieve the purposes mentioned above, one embodiment of the present invention is to provide a back plate structure in a PDP, which includes: a substrate, and a plurality of address electrodes are printed on the substrate; a dielectric layer printed on the substrate and covered the address electrodes; a plurality of horizontal barrier ribs printed on the dielectric layer; and a plurality of vertical barrier ribs printed on the dielectric layer. The horizontal barrier ribs and the vertical barrier ribs are crossed over to form a plurality of lattice-like discharge cells, wherein the vertical barrier ribs and the horizontal barrier ribs intersect to form right angles for an enclosed space on each discharge cell. The bottom-surface of the discharge cell is the surface of the dielectric layer, and at least one projection protruded to each of the discharge cells is printed among the two adjacent horizontal barrier ribs and the two adjacent vertical barrier ribs. The phosphor material is printed on the bottom-surface of the discharge cell and the sidewalls surrounding the discharge cell enclosed by the two adjacent horizontal barrier ribs and the two adjacent vertical barrier ribs.

### BRIEF DESCRIPTION OF THE DRAWINGS

The foregoing aspects and many of the accompanying advantages of this invention will become more readily appreciated as the same becomes better understood by reference to the following detailed description when taken in conjunction with the accompanying drawings, wherein:

FIG. 1A is a top-view schematic diagram of partial discharge cells for the prior art;

FIG. 1B is a top-view schematic diagram of a single discharge cell for the prior art;

FIG. 1C is a cubic schematic diagram of a single discharge cell for the prior art;

FIG. 1D is a schematic diagram to demonstrate the phosphor printing for the prior art;

FIG. 1E is a schematic diagram to demonstrate the nonuniform thickness of the phosphor material for the prior art;

FIG. 2A is a top-view schematic diagram of partial discharge cells according to one embodiment of the present invention;

FIG. 2B is a top-view schematic diagram of a single discharge cell according to one embodiment of the present invention;

FIG. 2C is a cubic schematic diagram of a single discharge cell according to one embodiment of the present invention;

FIG. 2D is a schematic diagram to demonstrate the phosphor printing according to one embodiment of the present invention;

FIG. 2E is a schematic diagram to demonstrate the phosphor printing according to one embodiment of the present invention;

FIG. 3 is a top-view schematic diagram of a single discharge cell according to one embodiment of the present invention;

FIG.4A is a top-view schematic diagram for a single discharge cell of the comparison group.

FIG.4B is a cross-sectional schematic diagram of the measurement positions and sizes for a single discharge cell of the comparison group along the horizontal cutting-line a-a’.

FIG.4C is a cross-sectional schematic diagram of the measurement positions and sizes for a single discharge cell of the comparison group along the vertical cutting-line b-b’.

FIG.4D is a top-view schematic diagram for a single discharge cell according to one embodiment of the present invention.

FIG.4E is a cross-sectional schematic diagram of the measurement positions and sizes for a single discharge cell, and is along the horizontal cutting-line c-c’ according to one embodiment of the present invention.

FIG.4F is a cross-sectional schematic diagram of the measurement positions and sizes for a single discharge cell, and is along the vertical cutting-line d-d’ according to one embodiment of the present invention.

FIG.4G is a vertical cross-section photograph for a single discharge cell of the comparison group ,and is along the vertical cutting-line b-b’ in FIG.4A. 7

FIG.4H is a vertical cross-section photograph for a single discharge cell, and is along the vertical cutting-line d-d’ in FIG.4D according to one embodiment of the present invention.

FIG.5 is a top-view schematic diagram for a single discharge cell according to one embodiment of the present invention .

FIG.6 is a top-view schematic diagram for a single discharge cell according to one embodiment of the present invention.

FIG.7A is a cubic schematic diagram for a single discharge cell according to one embodiment of the present invention.

FIG.7B is a cubic photograph for a partial discharge cell according to one embodiment of the present invention.

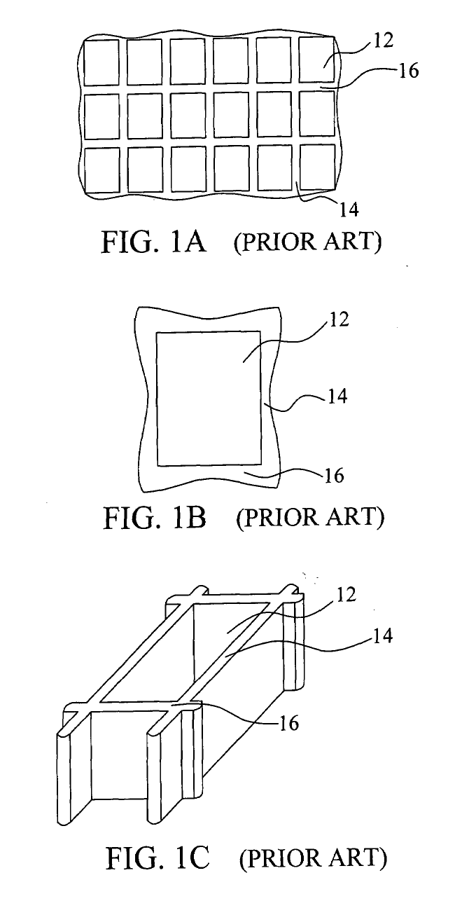

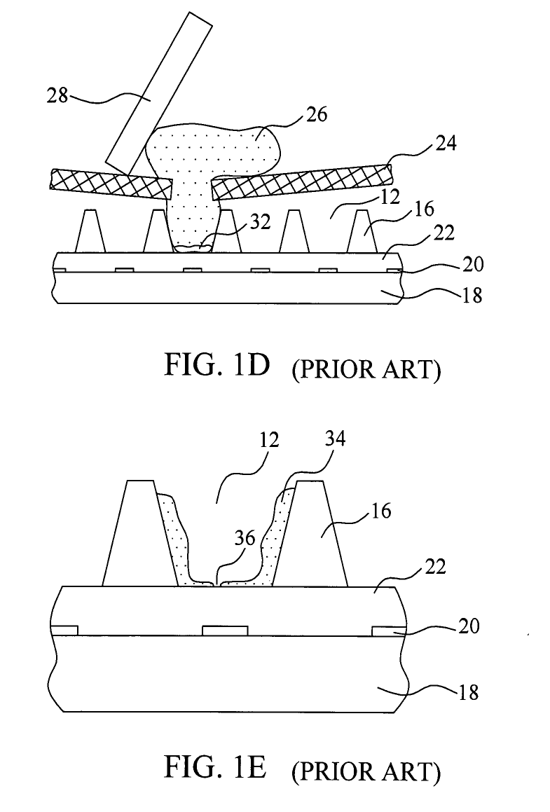

### DESCRIPTION OF THE PREFERRED EMBODIMENT

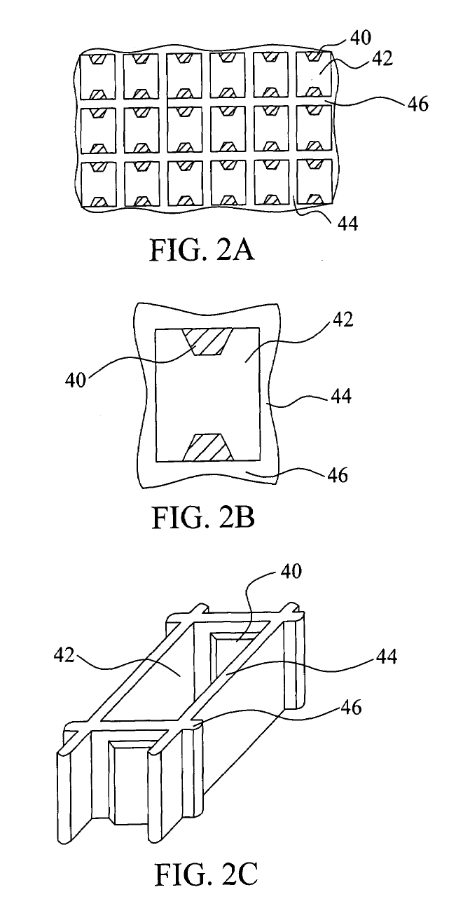

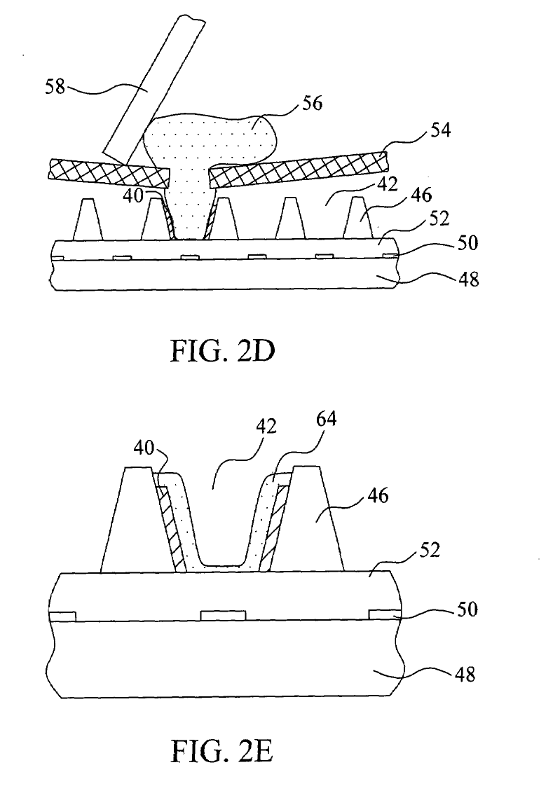

Regarding to one embodiment of the present invention from FIG.2A to FIG. 2C, FIG.2A is a top-view schematic diagram of partial discharge cells, FIG.2B and FIG.2C are the top-view and cubic schematic diagrams of a single discharge cell respectively. The horizontal barrier ribs 46 and the vertical barrier ribs 44 are crossed over to form a plurality of lattice-like discharge cells 42, wherein the 8 vertical barrier ribs 44 and the horizontal barrier ribs 46 intersect to form right angles for an enclosed space on each discharge cell 42. In this embodiment, each of two adjacent horizontal barrier ribs 46 respectively has a projection 40 protruded to each of the discharge cells 42, wherein the height of the projection 40 can be equal to or smaller than which of the horizontal barrier ribs 46. The height of the projection 40 is smaller than which of the horizontal barrier ribs 46 in this embodiment, as shown in FIG.2C.

In this embodiment, a phosphor material is printed on the bottom, lateral surfaces of the discharge cell and the sidewalls of the barrier ribs enclosing the discharge cell to increase the exciting area, and so as to increase the illumination efficiency of the PDP. Besides, a mesh screen corresponding to the discharge cell is adopted in an aligned printing for the phosphor material according to the present invention. FIG.2D is a schematic diagram to demonstrate printing the phosphor paste into the discharge cells according to one embodiment of the present invention. A plurality of address electrodes 50 are printed on a glass substrate 48, and a dielectric layer 52 is printed on the glass substrate 48 and covered the address electrodes 50. A plurality of horizontal barrier ribs 46 are printed on the dielectric layer 52, and the space between two adjacent horizontal barrier ribs 46 is the discharge cell 42. The phosphor paste 56 is printed into the discharge cell 42 through the net of a mesh screen 54 by using a squeegee 58. Because the opening of the net in the mesh screen 54 is normally smaller than the opening of the discharge cell 42, the 9 phosphor paste 56 will reach the projection 40 of the horizontal barrier ribs 46 first during the phosphor printing. Thus, the air can be exhausted from the two sides of the projection 40, so the bubbles will not be produced. Accordingly, the uniform phosphor layers can be formed after the solvent of the phosphor paste 56 is evaporated by a firing procedure. As shown in FIG.2E, a phosphor material 64 is uniformly printed on the bottom-surface of the discharge cell 42, the lateral surface of the horizontal barrier ribs 46 enclosing the discharge cell 42, and the surfaces of the projection 40.

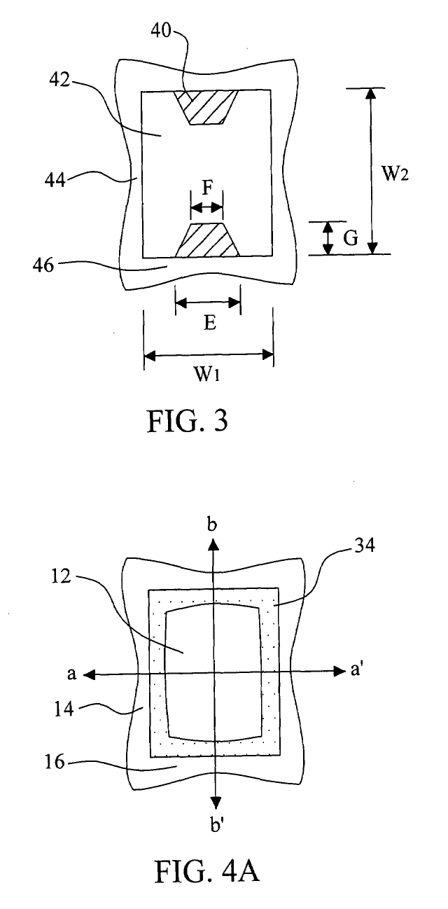

FIG.3 is a top-view schematic diagram of a single discharge cell according to one embodiment of the present invention to explain the requirements of the size design for the projection of the barrier rib. In this embodiment, the projection 40 of the horizontal barrier rib 46 is a trapezoidal-extender. The trapezoidal long-side is connected with the horizontal barrier rib 46, and the trapezoidal short-side is opposed to the trapezoidal long-side and faced the discharge cell 42. The thickness G of the projection 40 is defined as the perpendicular distance between the trapezoidal long-side and the trapezoidal short-side. Wherein the length E of the trapezoidal long-side is 20% to 50% of the horizontal width WI in the discharge cell 42, the length F of the trapezoidal short-side is 10% to 30% of the horizontal width WI in the discharge cell 42, and the thickness G of the projection 40 is 5% to 20% of the vertical width W₂ in the discharge cell 42. The related requirements on the size design are listed in Table.l.

TABLE 1
Requirements of the size design for the
projection of the barrier rib for one embodiment
according to the present invention.
Size design

| | |
|---|---|
| G | 5% to 20% of W₂ |
| F | 10% to 30% of W₁ |
| E | 20% to 50% of W₁ |

To verify the effectiveness, some samples are manufactured according to the present invention, and the thickness of the phosphor material is measured and compared for the samples of one embodiment in the present invention and the comparison group.

Please continue to refer to FIG.3, the sample sizes of one embodiment according to the present invention and the comparison group are listed in Table 2 .

TABLE 2
Sample sizes of the present invention and the
comparison group.

| Unit: μm | W₂ | W₁ | G | F | E |
|---|---|---|---|---|---|
| Present invention | 980 | 290 | 130 | 65 | 90 |
| Comparison group | 980 | 290 | 0 | 0 | 0 |

The same quantity of phosphor paste and the same process condition of the phosphor printing are respectively applied to print the phosphor material on the samples for the present invention and the comparison group. To measure the thickness of the phosphor material, it needs to cut the sample in advance before taking pictures and measuring.

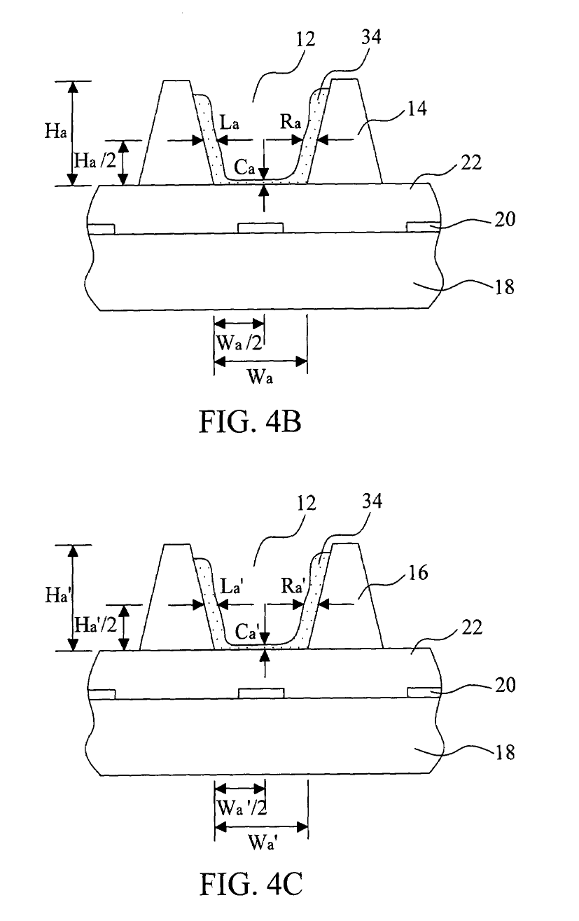

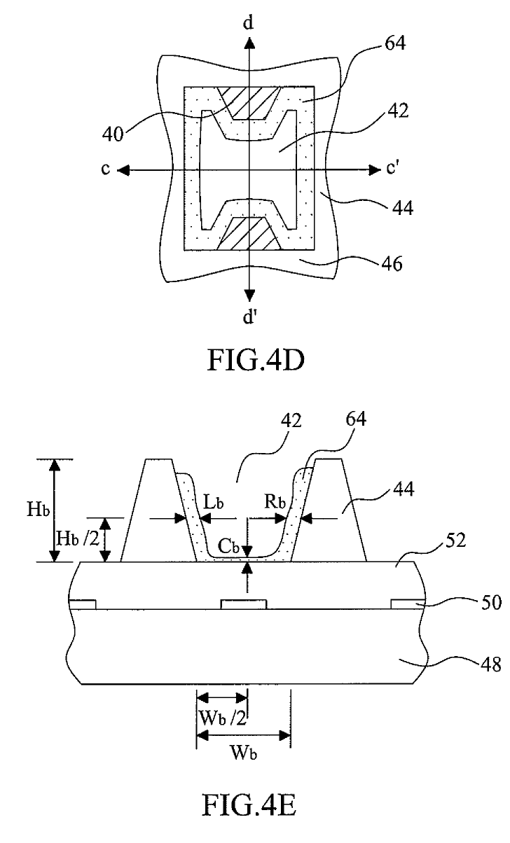

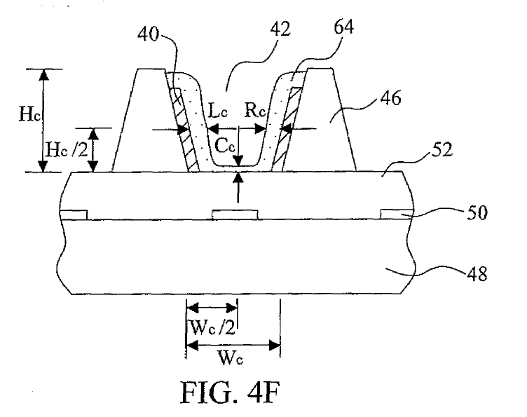

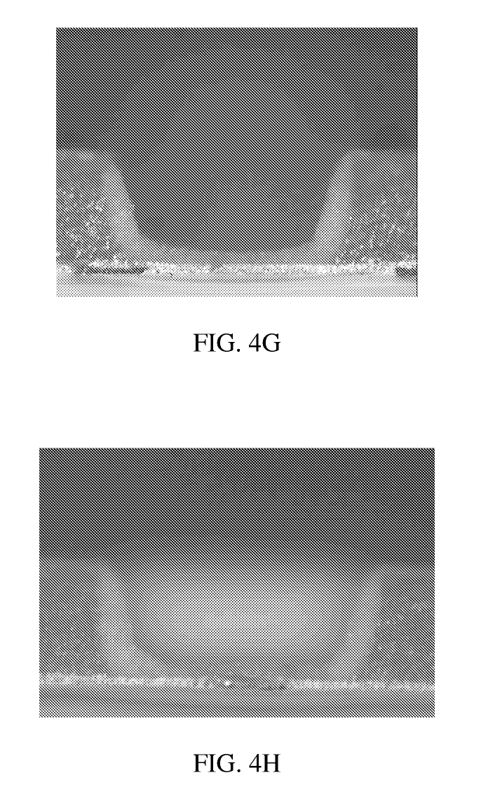

Please refer to FIG. 4A to FIG. 4H, FIG. 4A is a top-view schematic diagram for a single discharge cell of the comparison group, wherein the phosphor material 34 is printed on the sidewalls of vertical barrier ribs 14 and the horizontal barrier ribs 16 surrounding the discharge cell 12. The horizontal cutting-line a-a’ is along the vertical central-line of the discharge cell 12, and the vertical cutting-line b-b’ is along the horizontal central-line of the discharge cell 12.

FIG.4B is a cross-sectional schematic diagram of the measurement positions and sizes for a single discharge cell of the comparison group along the horizontal cutting-line a-a’. The Wa is the horizontal width of the discharge cell 12, and Ha is the height of the vertical barrier ribs 14 on the discharge cell 12. The Ca, La and Ra respectively represent the measured thickness of the phosphor material 34 in the center of the bottom-surface, central height of the left barrier ribs and central height of the right barrier ribs on the discharge cell 12.

FIG.4C is a cross-sectional schematic diagram of the measurement positions and sizes for a single discharge cell of the comparison group along the vertical cutting-line b-b’, which is similar to FIG. 4B. The Wa’ is the vertical width of the discharge cell 12, and Ha’ is the height of the horizontal barrier ribs 16 on the discharge cell 12. The Ca’, La’ and Ra’ respectively represent the measured thickness of the phosphor material 34 in the center of the bottom-surface, central height of the left barrier ribs, and central height of the right barrier ribs on the discharge cell 12.

FIG.4D is a top-view schematic diagram for a single discharge cell according to one embodiment of the present invention. Each of the two horizontal barrier ribs 46 respectively has a projection 40 protruded to the discharge cell 42. A phosphor material 64 is printed on the bottom-surface of the discharge cell 42, the surfaces of the vertical barrier ribs 44 ,and the horizontal barrier ribs 46 enclosing the discharge cell 42.

The phosphor material 64 is printed on the bottom-surface of the discharge cell 42 and the sidewalls surrounding the discharge cell 42 enclosed by the vertical barrier ribs 44 and the horizontal barrier ribs 46. The horizontal cutting-line c-c’ is along the vertical central-line of the discharge cell 42, and the vertical cutting-line d-d’ is along the horizontal central-line of the discharge cell 42.

FIG.4E is a cross-sectional schematic diagram of the measurement positions and sizes for a single discharge cell along the horizontal cutting-line c-c’ according to one embodiment of the present invention. The Wb is the horizontal width of the discharge cell 42, and Hb is the height of the vertical barrier ribs 44 on the discharge cell 42. The Cb, Lb and Rb respectively represent the measured thickness of the phosphor material 64 in the center of the bottom-surface, central height of the left barrier ribs, and central height of the right barrier ribs on the discharge cell 42.

FIG. 4F is a cross-sectional schematic diagram of the measurement positions and sizes for a single discharge cell along the vertical cutting-line d-d’ according to one embodiment of the present invention. The Wc is the vertical width of the discharge cell 42, and H, is the height of the horizontal barrier ribs 46 on the discharge cell 42. The Cc, L, and R, respectively represent the measured thickness of the phosphor material 64 in the center of the bottom-surface, central height of the left barrier ribs, and central height of the right barrier ribs on the discharge cell 42.

FIG. 4G is a vertical cross-section photograph for a single discharge cell of the comparison group along the vertical cutting-line b-b’ in FIG.4A. FIG.4H is a vertical cross-section photograph for a single discharge cell along the vertical cutting-line d-d’ in FIG.4D according to one embodiment of the present invention. The photographs of real samples are provided herein for the people skilled in the art to compare with the aforementioned schematic diagrams, and so as to be able to understand the present invention more concretely.

The measurement results of the film thickness for the phosphor material of the comparison group are listed in Table.3.

TABLE 3
Measurement results of the film thickness of the phosphor material
for the phosphor material of the comparison group.

| | Vertical cross-section | | | Horizontal cross-section | | |
|---|---|---|---|---|---|---|
| | along the cutting-line b-b′ | | | along the cutting-line a-a′ | | |
| Film | Lₐ′ | Cₐ′ | Rₐ′ | Lₐ | Cₐ | Rₐ |
| thickness | | | | | | |
| (μm) | 44.02 | 13.35 | 43.42 | 31.12 | 12.52 | 31.57 |
| Side/bottom | Lₐ′/Cₐ′ | | Rₐ′/Cₐ′ | Lₐ/Cₐ | | Rₐ/Cₐ |
| ratio | | | | | | |
| | 3.3 | | 3.25 | 2.49 | | 2.52 |

The measurement results of the film thickness for the phosphor material of the present embodiment are listed in Table.4.

TABLE 4
Measurement results of the film thickness for the
phosphor material of the present embodiment.

| | Vertical cross-section | | | Horizontal cross-section | | |
|---|---|---|---|---|---|---|
| | along the cutting-line d-d′ | | | along the cutting-line c-c′ | | |
| Film | L_{c} | C_{c} | R_{c} | L_{b} | C_{b} | R_{b} |
| thickness | | | | | | |
| (μm) | 35.25 | 12.75 | 36.07 | 27.02 | 12.17 | 27.34 |
| Side/bottom | L_{c}/C_{c} | | R_{c}/C_{c} | L_{b}/C_{b} | | R_{b}/C_{b} |
| ratio | | | | | | |
| | 2.76 | | 2.83 | 2.22 | | 2.25 |

Therefore, the thickness of the phosphor material for the samples of one embodiment in the present invention and the comparison group can be compared under the same quantity of phosphor paste and the same process condition of the phosphor printing. It is found from Table.3 and Table.4 that the thickness of the phosphor material is smaller, and the side/bottom ratio is more close to the ideal value 2:1 for the sample of the present embodiment. It can infer that the packing-density of the phosphor material is better and so as to have larger discharge space for the sample of the present embodiment.

Consequently, one feature of the present invention is that the horizontal barrier ribs or the vertical barrier ribs enclosing the discharge cells have the projections protruded to the discharge cells, which can make the air exhaust from the sides of the projections during the printing of the phosphor paste. Thus, the nonuniform-thickness phenomenon caused by the bubbles in the phosphor material printed on the bottom-surface of the discharge cell is improved, so the packing-density of the phosphor material is increased to enlarge the discharge space of the discharge cell.

According to the spirit of the present invention, if only at least one projection protruded to the discharge cell is printed among the two adjacent horizontal barrier ribs and the two adjacent vertical barrier ribs enclosing the discharge cell, the phosphor material can be uniformly printed on the bottom, lateral surfaces of the discharge cell, and the sidewalls of the barrier ribs enclosing the discharge cell. Besides, the projection of the barrier rib has no special limitation. For example, in the foregoing embodiment, the projection of the two horizontal barrier ribs enclosing the discharge cell is a trapezoidal-extender, and the two vertical barrier ribs have no projection .

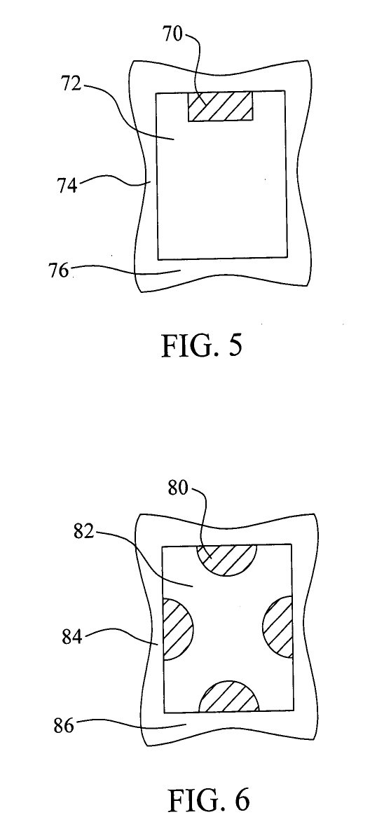

FIG. 5 is a top-view schematic diagram for a single discharge cell according to one embodiment of the present invention, the discharge cell 72 is an enclosed space formed by crossing two of the adjacent horizontal barrier ribs 76 and two of the adjacent vertical barrier ribs 74. One of the horizontal barrier ribs 76 has a projection 70 protruded to the discharge cell 72, wherein the projection 70 is a cuboid.

FIG. 6 is a top-view schematic diagram for a single discharge cell according to one embodiment of the present invention, the discharge cell 82 is an enclosed space formed by crossing two of the adjacent horizontal barrier ribs 86 and two of the adjacent vertical barrier ribs 84. Each of the horizontal barrier ribs 86 and each of the vertical barrier ribs 84 respectively have a projection 80 protruded to the discharge cell 82, wherein the projection 80 is a partial-cylinder.

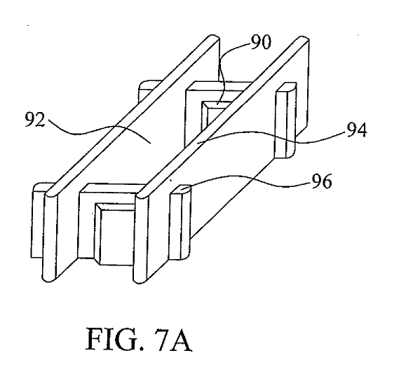

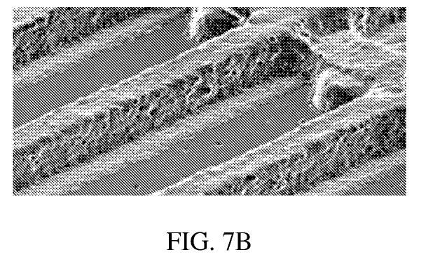

In addition, the horizontal barrier ribs and the vertical barrier ribs may be further designed to have height difference to improve the exhausting efficiency during the printing process of the phosphor paste. FIG.7A is a cubic schematic diagram for a single discharge cell according to one embodiment of the present invention, the discharge cell 92 is an enclosed space formed by crossing two of the adjacent vertical barrier ribs 94 and two of the adjacent horizontal barrier ribs 96. Each of the horizontal barrier ribs 96 has a projection 90 protruded to the discharge cell 92, wherein the height of the horizontal barrier ribs 96 is smaller than which of the vertical barrier ribs 94.

FIG. 7B is a cubic photograph for a partial discharge cell according to one embodiment of the present invention. The photograph of real sample is provided herein for the people skilled in the art to compare with FIG.7A, and so as to be able to understand the present invention more concretely.

To sum up, a structure with projections on barrier rib for the back plate of a PDP according to the present invention can improve the nonuniform-thickness phenomenon of the phosphor material printed on the bottom-surface of the discharge cell caused by the bubbles, which is produced during the phosphor printing. The packing-density of the phosphor material is increased, and so as to enlarge the discharge space of the discharge cell. Accordingly, the problem of flicker-noises on display panel is resolved, and the manufacturing yield and illumination efficiency are promoted. Furthermore, the horizontal barrier ribs and the vertical barrier ribs may be further designed to have height difference to improve the exhausting efficiency during the printing process of the phosphor paste.

The foregoing descriptions of specific embodiments of the present invention have been presented for purposes of illustrations and description. They are not intended to be exclusive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to particular use contemplated. It is intended that the scope of the invention be defined by the Claims appended hereto and their equivalents.

What is claimed is:

1. A back plate structure of a Plasma Display Panel (PDP), comprising:
a substrate;
a plurality of address electrodes printed on the substrate;
a dielectric layer printed on the substrate and covered the address electrodes;
a plurality of horizontal barrier ribs printed on the dielectric layer; and
a plurality of vertical barrier ribs printed on the dielectric layer, wherein the horizontal barrier ribs and the vertical barrier ribs are crossed over to form a plurality of lattice-like discharge cells; and each of the discharge cells is an enclosed space formed by crossing two of the adjacent vertical barrier ribs and two of the adjacent horizontal barrier ribs, wherein the bottom-surface of the discharge cell is the surface of the dielectric layer, and at least one projection protruded to each of the discharge cells is printed among the two adjacent horizontal barrier ribs and the two adjacent vertical barrier ribs.

2. The back plate structure of a PDP according to claim 1, wherein each of the two adjacent horizontal barrier ribs respectively has a projection protruded to each of the discharge cells.

3. The back plate structure of a PDP according to claim 1, wherein each of the two adjacent vertical barrier ribs respectively has a projection protruded to each of the discharge cells.

4. The back plate structure of a PDP according to claim 1, wherein each of the two adjacent horizontal barrier ribs and each of the two adjacent vertical barrier ribs respectively have a projection protruded to each of the discharge cells.

5. The back plate structure of a PDP according to claim 1, wherein the material of the address electrodes is metal.

6. The back plate structure of a PDP according to claim 1, further comprising a phosphor material printed on the bottom-surface of the discharge cell and the sidewalls surrounding the discharge cell enclosed by the two adjacent horizontal barrier ribs and the two adjacent vertical barrier ribs.

7. The back plate structure of a PDP according to claim 1, wherein the projection is a cuboid, a partial-cylinder, a trapezoidal-extender or combinations thereof.

8. The back plate structure of a PDP according to claim 1, wherein the projection is a trapezoidal-extender, the trapezoidal long-side of the trapezoidal-extender is connected with the horizontal barrier rib or the vertical barrier rib enclosing the discharge cell; wherein the side of the discharge cell connected with the trapezoidal-extender is a first side, and the side of the discharge cell perpendicular to the first side is a second side, wherein the length of the first side is a first width, and the length of the second side is a second width; wherein the length of the trapezoidal long-side is 20% to 50% of the first width, wherein the trapezoidal short-side of the trapezoidal-extender is opposed to the trapezoidal long-side and faced the discharge cell; and the length of the trapezoidal short-side is 10% to 30% of the first width, wherein the thickness of the projection is the perpendicular distance between the trapezoidal long-side and the trapezoidal short-side, and the thickness of the projection is 5% to 20% of the second width.

9. The back plate structure of a PDP according to claim 1, wherein the height of the projection of the barrier rib is equal to or smaller than the height of the barrier rib.

10. The back plate structure of a PDP according to claim 1, wherein the heights of the horizontal barrier ribs and the vertical barrier ribs are the same.

11. The back plate structure of a PDP according to claim 1, wherein the horizontal barrier ribs and the vertical barrier ribs have a height difference.

12. The back plate structure of a PDP according to claim 1, wherein the material of the substrate is glass.

13. A back plate structure of a PDP, comprising:
a substrate;
a plurality of address electrodes are printed on the substrate;
a dielectric layer printed on the substrate and covered the address electrodes;
a plurality of horizontal barrier ribs printed on the dielectric layer;
a plurality of vertical barrier ribs printed on the dielectric layer, wherein the horizontal barrier ribs and the vertical barrier ribs are crossed over to form a plurality of lattice-like discharge cells; and each of the discharge cells is an enclosed space formed by crossing two of the adjacent vertical barrier ribs and two of the adjacent horizontal barrier ribs; wherein the bottom-surface of the discharge cell is the surface of the dielectric layer, and at least one projection protruded to each of the discharge cells is printed among the two adjacent horizontal barrier ribs and the two adjacent vertical barrier ribs; and
a phosphor material printed on the bottom-surface of the discharge cell and the sidewalls surrounding the discharge cell enclosed by the two adjacent horizontal barrier ribs and the two adjacent vertical barrier ribs.

14. The back plate structure of a PDP according to claim 13, wherein the material of the address electrodes is metal.

15. The back plate structure of a PDP according to claim 13, wherein the material of the substrate is glass.

16. The back plate structure of a PDP according to claim 13, wherein the projection is a cuboid, a partial-cylinder, a trapezoidal-extender or combinations thereof.
